(19) United States
(12) Patent Application Publication
(10) Pub. No.: US 2010/0110506 A1
(43) Pub. Date: May 6, 2010

(54) IMAGE READING APPARATUS, IMAGE FORMING APPARATUS AND METHOD FOR IMAGE READING

(75) Inventors: Hiroyo KATOU, Shizuoka-Ken (JP); Yoshikatsu KAMISUWA, Tokyo (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/579,148

(22) Filed: Oct. 14, 2009

Related U.S. Application Data
(60) Provisional application No. 61/112,019, filed on Nov. 6, 2008.

(51) Int. Cl. H04N 1/04

(52) U.S. Cl. 358/488; 358/498

(57) ABSTRACT

An image reading apparatus of the invention includes an auto document feeder to automatically feed an original document along a conveyance path, a first sensor that is provided on the conveyance path and detects a first passage time of the original document, a second sensor that is provided at a position different from a position of the first sensor in a conveyance direction of the original document and also different therefrom in a direction perpendicular to the conveyance direction and detects a second passage time of the original document, and a skew determination section that obtains a skew amount of the original document from a difference between the first passage time detected by the first sensor and the second passage time detected by the second sensor and determines occurrence of a skew of the original document based on the skew amount.

### CROSS-REFERENCE TO RELATED APPLICATIONS

This application is based upon and claims the benefit of priority from U.S. provisional application 61/112019, filed on Nov. 6, 2008, the entire contents of each of which are incorporated herein by reference.

### TECHNICAL FIELD

The present invention relates to an image reading apparatus, an image forming apparatus and a method for image reading, and particularly to an image reading apparatus including an ADF (Auto Document Feeder), an image forming apparatus and a method for image reading.

### BACKGROUND

Some image reading apparatuses such as scanners or some image forming apparatuses such as copiers or MFPs (Multi Function Peripheral) include an ADF for continuously reading plural original documents.

In general, the ADF includes a guide for aligning the position and orientation of an original document and the original document is set along this guide, so that stable and reliable reading of the original document can be performed. However, when the original document is disorderly set on the ADF without using the guide, a document skew (phenomenon in which the original document is conveyed in an obliquely inclined state) can occur. In order to handle a large number of original documents in a short time, it is necessary to increase the conveyance speed of the original documents or to shorten the interval between the conveyed original documents. This results in that the document skew becomes large.

When the original document is skewed, an image of the read original document may be distorted, or paper clogging (jam) may occur.

JP-A 2001-358914 discloses a technique to correct the distortion of an image due to a skew of an original document. In this technique, the skew of the original document is determined based on the position and width of the original document detected from the output of a line sensor to read the image of the original document, and the image of the read original document is corrected based on the determined skew.

However, the technique disclosed in JP-A2001-358914 is only for correcting the distortion of the image due to the skew, and the paper jam due to the skew can not be prevented. Many original documents such as handwritten original documents are one and only, and if they are torn or wrinkled by the paper jam, a very serious damage may be caused.

### SUMMARY

The present invention is made in view of the above, and it is an object of the invention to provide an image reading apparatus, an image forming apparatus and a method for image reading, in which when a document skew occurs in the inside of an ADF, the occurrence of the document skew is detected without adding a specific sensor, the distortion of an image is corrected, and the occurrence of a paper jam due to the skew can be prevented.

In order to achieve the object, according to an aspect of the invention, an image reading apparatus includes an auto document feeder to automatically feed an original document along a conveyance path, a first sensor that is provided on the conveyance path and detects a first passage time of the original document, a second sensor that is provided at a position different from a position of the first sensor in a conveyance direction of the original document and also different therefrom in a direction perpendicular to the conveyance direction and detects a second passage time of the original document, and a skew determination section that obtains a skew amount of the original document from a difference between the first passage time detected by the first sensor and the second passage time detected by the second sensor and determines occurrence of a skew of the original document based on the skew amount.

Besides, according to another aspect of the invention, an image forming apparatus includes an auto document feeder to automatically feed an original document along a conveyance path, a first sensor that is provided on the conveyance path and detects a first passage time of the original document, a second sensor that is provided at a position different from a position of the first sensor in a conveyance direction of the original document and also different therefrom in a direction perpendicular to the conveyance direction and detects a second passage time of the original document, a skew determination section that obtains a skew amount of the original document from a difference between the first passage time detected by the first sensor and the second passage time detected by the second sensor and determines occurrence of a skew of the original document based on the skew amount, a line sensor to read the original document fed by the auto document feeder, and an image forming section to print image data of the original document read by the line sensor onto a sheet.

Besides, according to another aspect of the invention, a method for image reading includes automatically feeding an original document along a conveyance path by an auto document feeder, detecting a first passage time of the original document by a first sensor provided on the conveyance path, detecting a second passage time of the original document by a second sensor provided at a position different from a position of the first sensor in a conveyance direction of the original document and also different therefrom in a direction perpendicular to the conveyance direction, obtaining a skew amount of the original document from a difference between the first passage time detected by the first sensor and the second passage time detected by the second sensor, and determining occurrence of a skew of the original document based on the skew amount.

### DESCRIPTION OF THE DRAWINGS

In the accompanying drawings:

FIG. 1 is a perspective view showing an outer appearance example of an image forming apparatus of an embodiment of the invention;

FIG. 2 is a sectional view showing a structural example of the image forming apparatus of the embodiment of the invention;

FIG. 3 is a sectional view showing a structural example of an image reading apparatus of the embodiment of the invention;

FIG. 4 is a plan view showing a structural example and an arrangement example of rollers and sensors provided on a conveyance path of an original document;

FIGS. 5A to 5D are first views (clockwise skew) for explaining the operation principle of skew amount detection of the embodiment;

FIGS. 6A to 6D are second views (counterclockwise skew) for explaining the operation principle of skew amount detection of the embodiment;

FIG. 7 is a flowchart showing an example of a process required to determine the occurrence of a skew;

FIG. 8 is a view showing an arrangement example of sensors which can be applied to the image forming apparatus of the embodiment and an arrangement example which can not be applied thereto;

FIG. 9 is a function block diagram showing functions mainly relating to skew detection and skew correction in the functions of the image forming apparatus of the embodiment;

FIGS. 10A and 10B are views for explaining the concept of skew correction; and

FIG. 11 is a flowchart showing an example of a detailed process relating to skew determination, conveyance speed determination, display, conveyance control and skew correction.

### DETAILED DESCRIPTION

An image reading apparatus, an image forming apparatus, and a method for image reading according to an embodiment of the invention will be described with reference to the accompanying drawings.

### (1) Structure of the Image Forming Apparatus and the Image Reading Apparatus

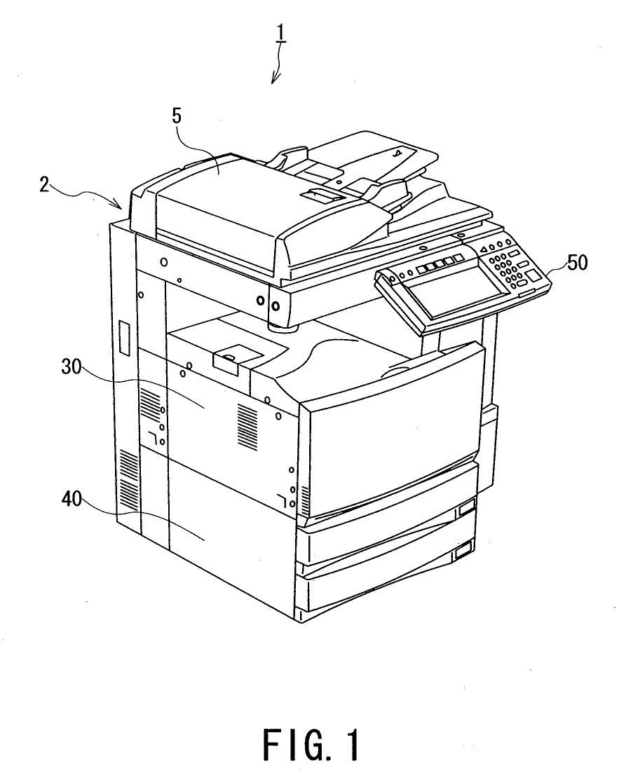

FIG. 1 is a view showing an outer appearance example of a copier (or MFP: Multi-Function Peripheral) as a typical example of an image forming apparatus 1 of the embodiment.

The image forming apparatus 1 includes an image reading apparatus 2, an image forming section 30, a paper feed section 40, an operation section 50 and the like.

The image reading apparatus 2 optically reads an original document placed on a document table or an original document inputted to an ADF (Auto Document Feeder) 5 and generates image data.

The image forming section 30 prints the image data by using an electrophotographic system onto a sheet fed from the paper feed section 40.

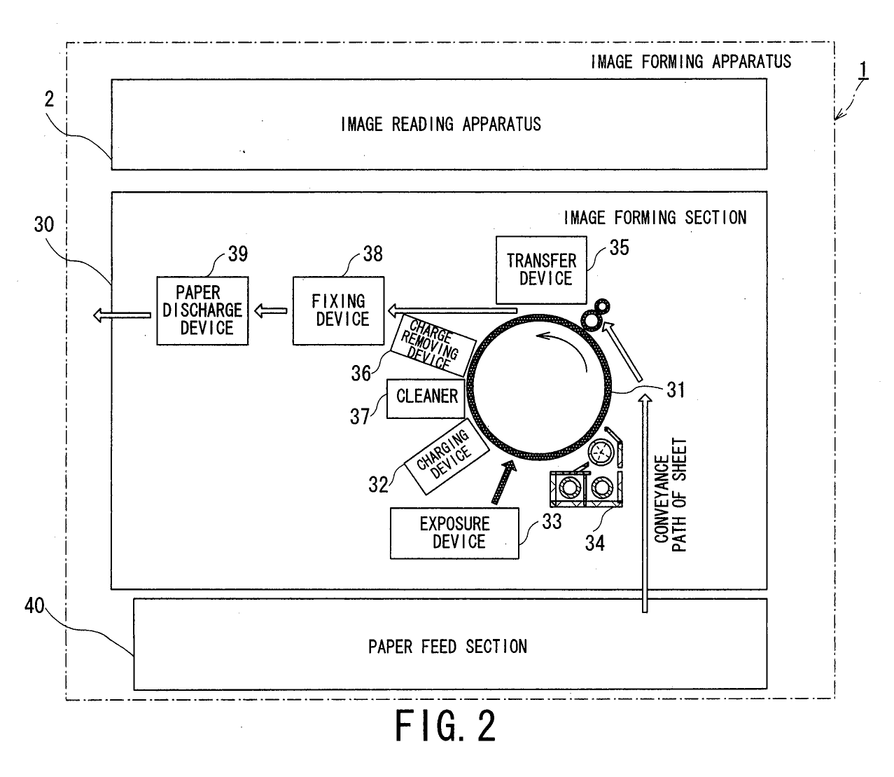

The operation section 50 includes a display section as a user interface and various operation buttons. FIG. 2 is a schematic sectional view showing an inner structural example of the image forming section 30.

The image forming section 30 includes a photoconductive drum 31 rotating in an illustrated arrow direction in the vicinity of a center part. A charging device 32, an exposure device 33, a developing device 34, a transfer device 35, a charge removing device 36, and a cleaner 37 are sequentially disposed around the photoconductive drum 31 from an upstream side to a downstream side in the rotation direction.

The charging device 32 uniformly charges the surface of the photoconductive drum 31 to a specified potential. The exposure device 33 irradiates the surface of the photoconductive drum 31 with a laser light modulated according to the magnitude of image data. When the laser light is irradiated, the potential at that portion is reduced, and an electrostatic latent image is formed on the surface of the photoconductive drum 31.

The developing device 34 causes a developer to adhere to the surface of the photoconductive drum 31, and develops the electrostatic latent image. The electrostatic latent image is developed with toner in the developer, and a toner image is formed on the surface of the photoconductive drum 31.

Meanwhile, a sheet is conveyed to a transfer position (the position where the photoconductive drum 31 and the transfer device 35 face each other) from a paper feed tray 7 of the paper feed section 40, and the toner image on the photoconductive drum 31 is transferred to the sheet by the transfer device 35.

The sheet on which the toner image is transferred is conveyed to a fixing device 38 disposed downstream of the transfer device 35, and is heated and pressed here, and the toner image is fixed to the sheet. The sheet subjected to the fixing process is discharged to the outside by a paper discharge device 39.

After the transfer to the sheet is completed, the surface charge of the photoconductive drum 31 is removed by the charge removing device 36, and the toner remaining on the surface is removed by the cleaner 37.

By repeating the above process, continuous printing can be performed.

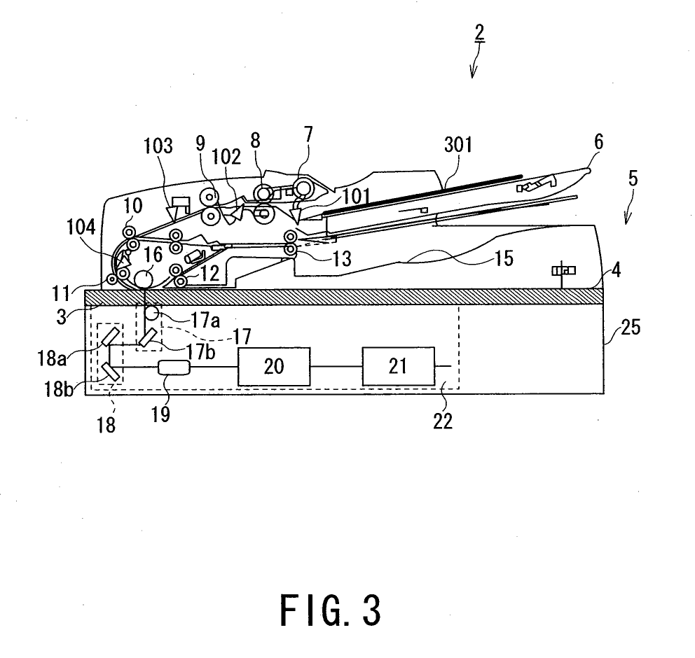

FIG. 3 is a sectional view showing a structural example of the image reading apparatus 2 of the embodiment. A document read table 3 is disposed at an upper part of a main body housing 25 of the image reading apparatus 2, and a contact glass is disposed at an upper part of the document read table 3. An openable and closable document press plate 4 is provided at an upper part of the document read table 3, and the document press plate 4 presses an original document set on the document read table 3 so that the document is brought into close contact with the contact glass of the document read table 3.

The auto document feeder (ADF) 5 is disposed at an upper part of the document press plate 4. The auto document feeder 5 includes a document tray 6. The original document 301 placed on the original document tray 6 is picked up by a pickup roller 7, and is separated one by one by a paper feed roller 8. The document is conveyed by a conveyance roller 9, an intermediate conveyance roller 10 and a pre-read roller 11 to a position (read position) where it contacts with the document read table 3. Thereafter, the document is conveyed by a post-read roller 12 and a paper discharge roller 13 onto a storage tray 15.

A white reference roller 16 for shading correction is disposed at the read position between the auto document feeder 5 and the document read table 3. The auto document feeder 5 has an integral structure with the document press plate 4, and when the document press plate 4 is opened or closed, the auto document feeder 5 is also opened or closed.

An exposure scanning optical unit 22 including a first carriage 17, a second carriage 18, a lens 19, a CCD (Charge Coupled Device) sensor 20, and a read control section 21 is disposed in the inside of the main body housing 25. The first carriage 17 includes a light source 17a and a mirror 17b, and the second carriage 18 includes a mirror 18a and a mirror 18b.

When the original document 301 placed on the document read stand 3 is read, the first carriage 17 and the second carriage 18 are moved in the horizontal direction (sub-scanning direction). The light source 17a of the first carriage 17, for example, a fluorescent lamp irradiates a light to the original document 301 while moving. The reflected light from the original document 301 is sequentially reflected by the mirror 17b of the first carriage 17, and the mirror 18a and the mirror 18b of the second carriage 18, and is incident on the lens 19. The lens 19 condenses the incident light on the CCD sensor 20. In the CCD sensor 20, CCD elements as photoelectric conversion elements are arranged one-dimensionally, and the CCD sensor photoelectric-converts the incident light incident from the lens 19 and outputs analog image data (image signal) to the read control section 21. The exposure scanning optical unit 22 irradiates a light to the white reference roller 16 before scanning in the sub-scanning direction is performed, the reflected light from the white reference roller 16 is made incident on the CCD sensor 20 similarly to the above, and white reference data is obtained.

When the original document is automatically read, that is, when the original document 301 is set on the document tray of the auto document feeder 5, first, the light source 17a is turned on, and reading of the white reference roller 16 is performed to obtain the white reference data. Meanwhile, the set original document 301 is conveyed at a constant speed, and is conveyed to the read position (position of the white reference roller 16). At this time, the first carriage 17 and the second carriage 18 are in a stop state, and the light source 17a irradiates a light to the original document 301 passing through the read position. The reflected light from the original document 301 is incident on the CCD sensor 20 through the mirror 17b, the mirror 18a, the mirror 18b and the lens 19, and the image data of the image of the original document 301 is generated.

### (2) Detection of Skew of the Original Document

As stated above, the original document 301 set on the ADF 5 is conveyed to the read position by the five rollers, that is, the pickup roller 7, the paper feed roller 8, the conveyance roller 9, the intermediate conveyance roller 10 and the pre-read roller 11. Besides, four paper detection sensors, that is, a pre-feed sensor 101, a paper feed sensor 102, a conveyance sensor 103 and an intermediate conveyance sensor 104 are provided on the conveyance path of the original document. These paper detection sensors are, for example, photo sensors, and are put in an ON state when the leading edge of the original document 301 passes, and are put in an OFF state when the trailing edge of the original document 301 passes. By detecting a time when each of the paper detection sensors is changed from the OFF state to the ON state, a passage time of the original document 301 is obtained together with the paper detection sensor which detects the passage time. The respective paper detection sensors are originally provided to detect the occurrence of a paper jam of the original document 301.

In the image forming apparatus 1 and the image reading apparatus 2 of the embodiment, the arrangement of the paper detection sensors is contrived such that the occurrence of skew of the original document 301 is determined based on the passage time information of the original document 301 detected by the respective paper detection sensors, in addition to the detection of the occurrence of a paper jam. Further, when the skew occurs, not only the skew occurrence but also a skew amount (skew angle) is detected.

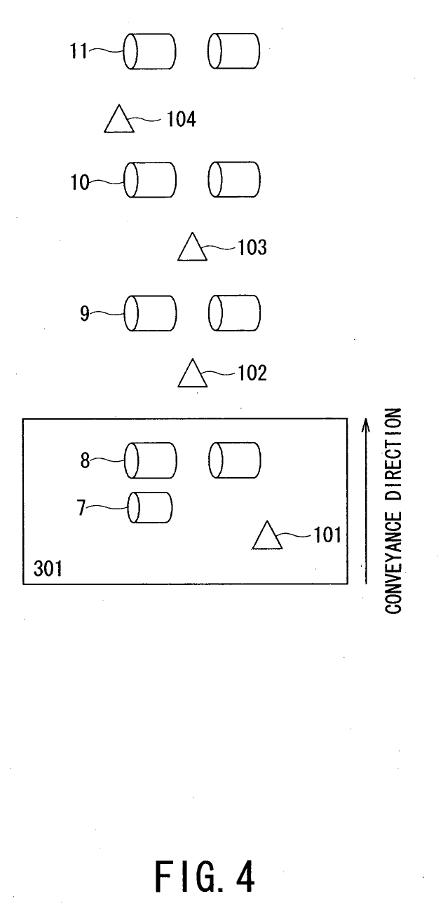

FIG. 4 is a view illustrating an arrangement of the pre-feed sensor 101, the paper feed sensor 102, the conveyance sensor 103 and the intermediate conveyance sensor 104, which are used for skew detection, is shown and which is two-dimensionally expanded in a sheet conveyance direction and a direction perpendicular thereto. FIG. 4 shows also the arrangement of the pickup roller 7, the paper feed roller 8, the conveyance roller 9, the intermediate conveyance roller 10, and the pre-read roller 11.

As is understood from FIG. 4, the paper feed sensor 102 (second sensor) is arranged at a position different from a position of the pre-feed sensor 101 (first sensor) in the sheet conveyance direction and also different therefrom in the direction perpendicular to the conveyance direction. That is, the paper feed sensor 102 and the pre-feed sensor 101 are arranged obliquely to the sheet conveyance direction.

In contrast, the conveyance sensor 103 (third sensor) is arranged at a position which is different from the position of the paper feed sensor 102 (second sensor) in the sheet conveyance direction but is equal thereto in the direction perpendicular to the conveyance direction. That is, the conveyance sensor 103 and the paper feed sensor 102 are arranged in parallel to the sheet conveyance direction.

Meanwhile, the relative positional relation between the intermediate conveyance sensor 104 and the conveyance sensor 103 is the same as the positional relation between the paper feed sensor 102 (second sensor) and the pre-feed sensor 101 (first sensor). The intermediate conveyance sensor 104 is arranged at a position different from the position of the conveyance sensor 103 in the sheet conveyance direction and also different therefrom in the direction perpendicular to the conveyance direction. A skew detection method of the original document 301 using the sensors arranged as stated above will be described below.

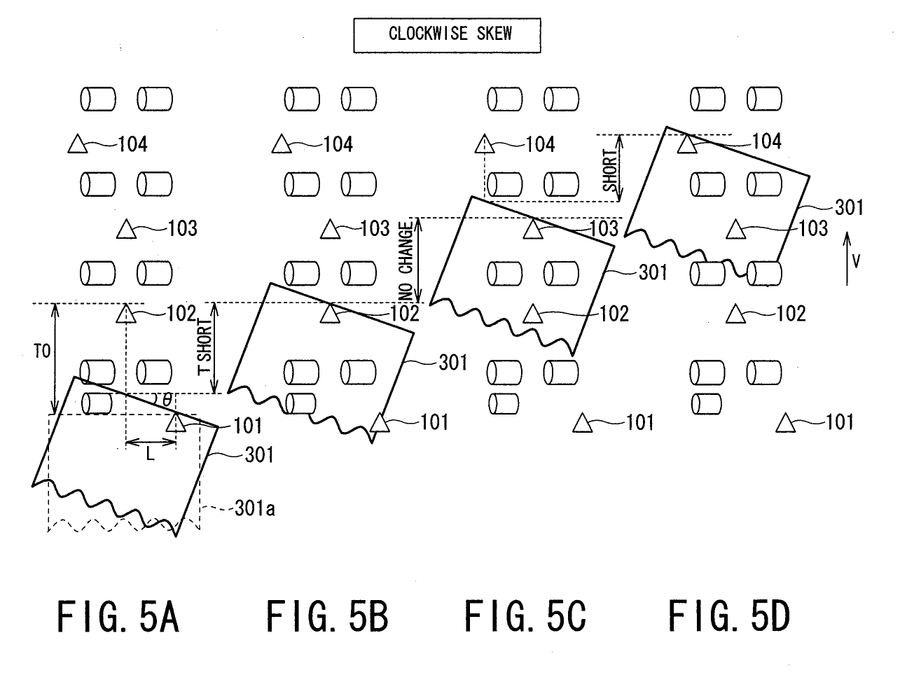

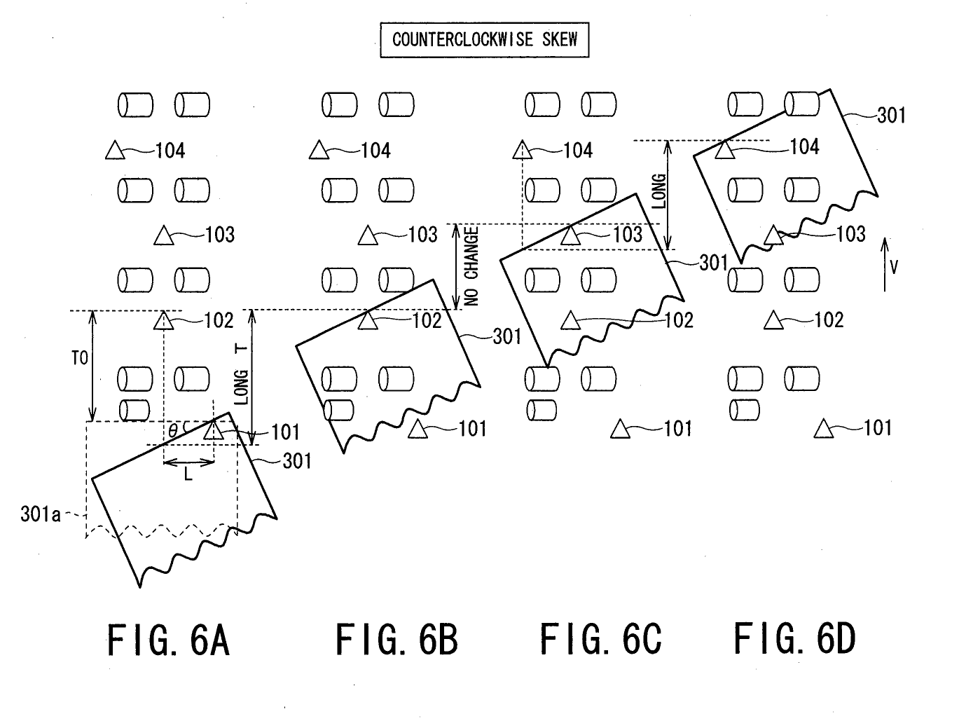

FIGS. 5A to 5D and FIGS. 6A to 6D are views for explaining the principle of the skew detection method of the embodiment. Among these, FIGS. 5A to 5D show a state where a clockwise skew occurs, and FIGS. 6A to 6D show a state where a counterclockwise skew occurs.

FIG. 5A shows a state where the leading edge of the original document 301 having a clockwise skew passes through the position of the pre-feed sensor 101. FIG. 5B shows a state where the sheet is further conveyed and the leading edge of the original document 301 passes through the position of the paper feed sensor 102. FIG. 5C shows a state where the leading edge of the original document 301 passes through the position of the conveyance sensor 103. FIG. 5D shows a state where the original document 301 is further conveyed, and the leading edge thereof passes through the position of the intermediate conveyance sensor 104.

As stated above, since the pre-feed sensor 101 and the paper feed sensor 102 are arranged obliquely to the conveyance direction of the original document 301, a period required for the document to pass the two sensors is different between an original document 301a (original document indicated by a broken line in FIG. 5A) in a normal state where a skew does not occur and the skewed original document 301. As shown in FIG. 5A, a period T required for the leading edge of the original document 301 to pass the pre-feed sensor 101 and the paper feed sensor 102 when the original document 301 is skewed clockwise is shorter than a passage period T0 when the document is not skewed (T<T0).

On the other hand, since the paper feed sensor 102 and the conveyance sensor 103 are arranged in parallel to the conveyance direction of the original document 301, a period required for the sheet to pass the two sensors is the same between a normal state where the sheet is not skewed and a state where the sheet is skewed.

The relative positional relation between the conveyance sensor 103 and the intermediate conveyance sensor 104 is the same as the positional relation between the pre-feed sensor 101 and the paper feed sensor 102 as stated above. Accordingly, a period T required for the original document 301 skewed in the clockwise direction to pass the two sensors is shorter than a passage period T0 when the document is not skewed (T<T0).

Also when the original document 301 skews in the counterclockwise direction, as shown in FIGS. 6A to 6D, a period T required for the leading edge of the original document 301 to pass the pre-feed sensor 101 and the paper feed sensor 102 is different from the passage period T0 in the normal state where the sheet is not skewed. However, in this case, the passage period T when the document is skewed is longer than the passage period T0 when the document is not skewed (T>T0). The same applies to a period for the original document 301 to pass the conveyance sensor 103 and the intermediate conveyance sensor 104.

A sheet skew amount s can be expressed by a skew angle θ (see FIG. 5A, FIG. 6A). When a distance between the pre-feed sensor 101 and the paper feed sensor 102 (or between the conveyance sensor 103 and the intermediate conveyance sensor 104) in the direction perpendicular to the conveyance direction is denoted by L, and a sheet conveyance speed is denoted by V0, the skew angle θ is expressed by a following equation.

tan(θ)=(T0−T)·(V0/L) (equation 1)

Where, the normal passage period T0 when there is no skew, the sheet conveyance speed V0, and the distance L are previously given values.

The passage period T in equation 1 is the period (T=t2−t1) calculated from a difference between a time (first passage time t1) when the leading edge of the original document 301 passes the pre-feed sensor 101 (first sensor) and a time (second passage time t2) when the leading edge passes the paper feed sensor 102 (second sensor). The skew angle θ can be calculated from this period (and T0, V0 and L described above) based on equation 1. When the skew angle θ is positive, the skew is clockwise, and when the angle is negative, the skew is counterclockwise.

The skew angle θ can also be calculated from a period calculated from a difference between a time when the leading edge of the original document 301 passes the conveyance sensor 103 and a time when the leading edge passes the intermediate conveyance sensor 104, and T0, V0 and L described above.

The conveyance speed V0 of the sheet used in equation 1 is a normal conveyance speed when a conveyance function failure due to abrasion or the like does not occur in the respective rollers. Accordingly, when abrasion or the like occurs in a roller and the actual conveyance speed V is remarkably deviated from the normal conveyance speed V0, there is a fear that an error occurs when the skew angle is obtained by using equation 1.

Then, in this embodiment, whether the actual conveyance speed V is remarkably deviated from the normal conveyance speed V0 is determined from the time (second passage time t2) when the leading edge of the original document 301 passes the paper feed sensor 102 and a passage time (third passage time t3) when the leading edge passes the conveyance sensor 103, the sensors 102 and 103 being arranged to be parallel to the conveyance direction.

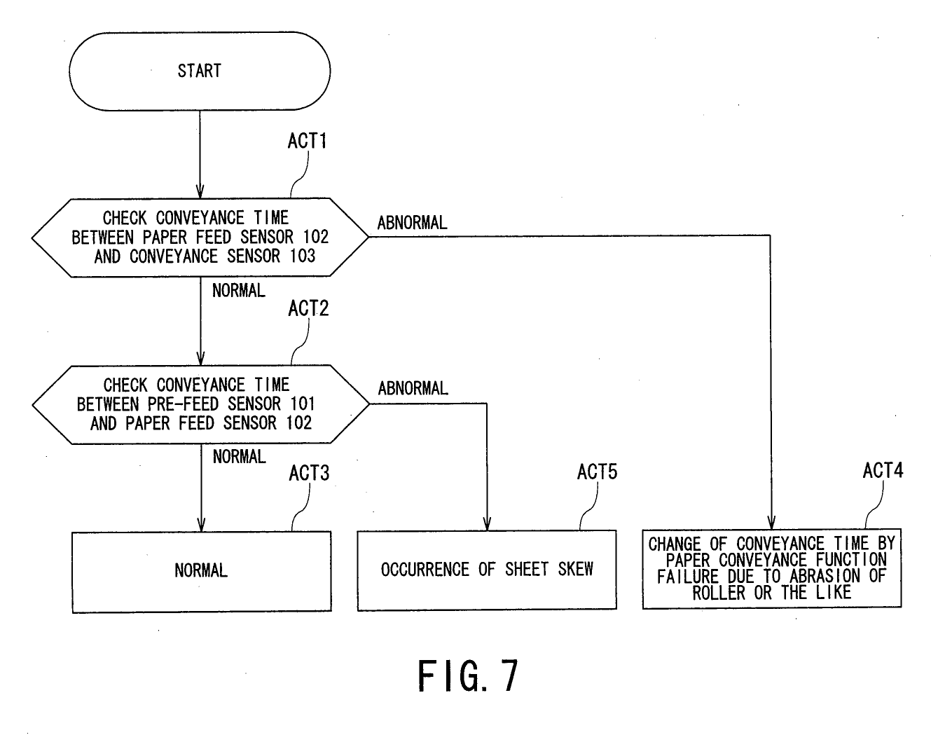

FIG. 7 is a flowchart showing an example of the determination process. At ACT 1, a conveyance time of the original document 301 between the two sensors 102 and 103 is obtained from a difference between the time t2 when the leading edge of the original document 301 passes the paper feed sensor 102 and a passage time t3 when the leading edge passes the conveyance sensor 103, and comparison check with a normal conveyance time is performed. Instead of the conveyance time, a conveyance speed may be used to perform the determination. It is determined to be abnormal when the difference of the conveyance time (or the conveyance speed) is not within a specified reference range. In this case, it is estimated that some trouble occurs in the paper conveyance function of the roller due to roller abrasion or the like.

When there is no abnormality in the conveyance time (or the conveyance speed) of the original document 301 between the paper feed sensor 102 and the conveyance sensor 103, an advance is made to a skew determination process at ACT 2. At ACT 2, a conveyance time between the pre-feed sensor 101 and the paper feed sensor 102 is checked. When this conveyance time is within a specified range, it is determined that a skew does not occur (normal), and when the conveyance time is outside the specified range, it is determined that a skew occurs (abnormal). At ACT 2, the skew angle θ is obtained based on equation 1, and normality or abnormality may be determined based on the skew angle θ.

In the above description, although each of the sensors detects the passage time of the leading edge of the original document 301, the trailing edge of the sheet may be detected instead of this. Besides, the skew determination at ACT 2 may be performed using a passage time between the conveyance sensor 103 and the intermediate conveyance sensor 104.

The arrangement of the respective sensors such as the pre-feed sensor 101, the paper feed sensor 102 and the conveyance sensor 103 is not limited to the arrangement of FIG. 4 (or FIG. 5A to FIG. 5D, FIG. 6A to FIG. 6D).

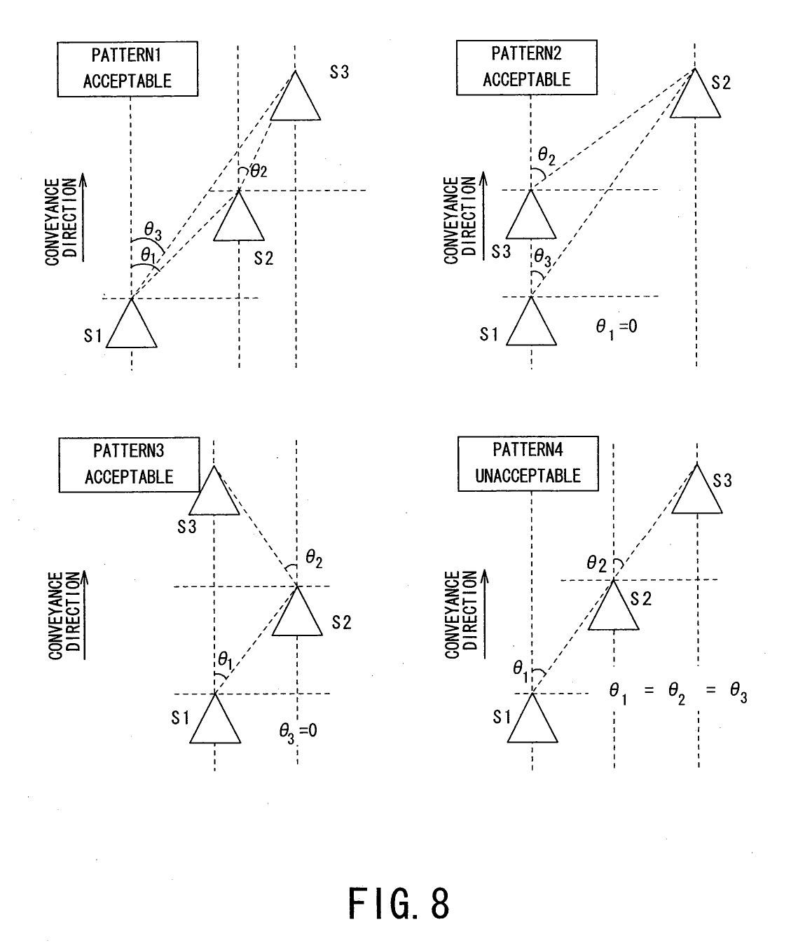

FIG. 8 is a view showing arrangement examples (pattern 1, pattern 2, pattern 3) which can be applied to the image forming apparatus 1 of the embodiment, and an arrangement example (pattern 4) which can not be applied thereto. In order to detect the skew angle, two sensors are required, and these are designated as a first sensor S1 and a second sensor S2. Besides, in order to separate the detection of the change of the sheet conveyance speed due to the roller abrasion or the like from the detection of the skew, one more sensor (this is designated as a third sensor S3) is required.

The first sensor S1 and the second sensor S2 for detecting the skew angle are required to be arranged at positions different from each other in the conveyance direction of the original document 301 and the direction perpendicular to this. In the arrangement example of FIG. 4 (or FIG. 5A to FIG. 5D, FIG. 6A to FIG. 6D), the first sensor S1 and the second sensor S2 correspond to the pre-feed sensor 101 and the paper feed sensor 102 (or the conveyance sensor 103 and the intermediate conveyance sensor 104).

On the other hand, the third sensor S3 can be freely arranged as illustrated in pattern 1, pattern 2 and pattern 3 unless the third sensor is arranged on a straight line connecting the first sensor S1 and the second sensor S2 as in pattern 4. In the arrangement example of FIG. 4 (or FIGS. 5A to 5D, FIGS. 6A to 6D), the third sensor S3 corresponds to the conveyance sensor 103.

### (3) Functions Relating to Skew Detection and Detailed Operation

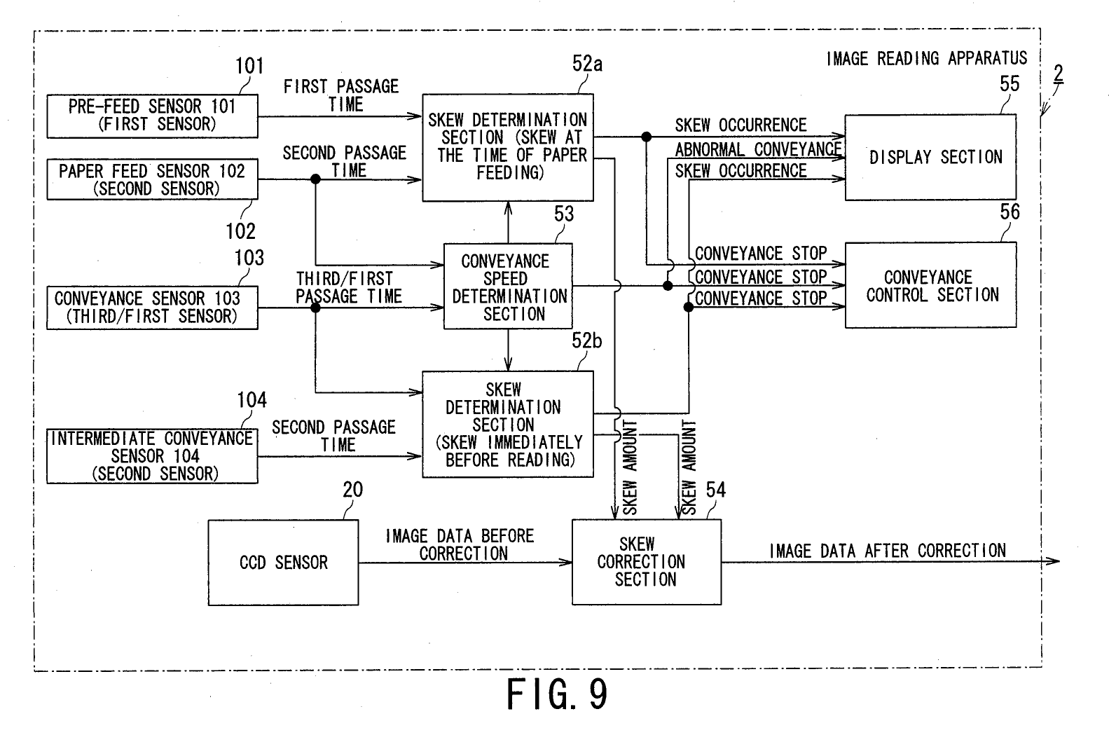

FIG. 9 is a block diagram particularly showing functions relating to skew detection and skew correction in the functions of the image reading apparatus 2 of the embodiment.

In order to realize these functions, in addition to the pre-feed sensor 101, the paper feed sensor 102, the conveyance sensor 103, and the intermediate conveyance sensor 104 described before, the image reading apparatus 2 includes a skew determination section 52 (a skew determination section 52a to determine a skew at the time of paper feeding, and a skew determination section 52b to determine a skew immediately before reading), a conveyance speed determination section 53, a skew correction section 54, a display section 55 and a conveyance control section 56.

In the function blocks, the skew determination section (skew at the time of paper feeding) 52a obtains a skew amount s1 from the difference between the first passage time t1 detected by the pre-feed sensor 101 (first sensor) and the second passage time t2 detected by the paper feed sensor 102 (second sensor), and determines the occurrence of a skew at the time of paper feeding of the original document 301 based on the skew amount s1. Specifically, for example, the skew amount s1 (skew angle θ) is obtained by the foregoing equation 1, the absolute value of the obtained skew amount s1 is compared with a threshold Smax1, and the occurrence of the skew is determined. The skew determination section 52a detects the skew which occurs at a relatively upstream side in the conveyance path of the original document 301 extending from the original document tray 6 to the read position. When it is determined that the skew occurs, an instruction is given so that the display section 55 displays to that effect, and in order to previously prevent a paper jam due to the skew from occurring, an instruction is given so that the conveyance control section 56 stops the conveyance of the original document 301.

The conveyance speed determination section 53 obtains the conveyance speed V of the original document 301 based on the third passage time t3 detected by the conveyance sensor 103 (third sensor) and the passage time t2 detected by the paper feed sensor 102. When the distance between the conveyance sensor 103 and the paper feed sensor 102 is denoted by D₂₋₃, the conveyance speed V can be obtained from, for example, V=D₂₋₃/(t3−t2).

When the obtained conveyance speed V is within a specified range, the skew determination section 52a (and the skew determination section 52b) performs the skew determination. On the other hand, when the conveyance speed V is outside the specified range, it is determined that some trouble occurs in the conveyance function itself of the original document 301 because of roller abrasion or the like. In this case, an instruction is given so that the display section 55 displays an alarm, or the conveyance control section 56 stops the conveyance of the original document 301.

The skew determination section (skew immediately before reading) 52b determines the presence or absence of the occurrence of a skew at a position just before the read position of the original document 301. For the skew determination section 52b, the conveyance sensor 103 functions as the first sensor, and the passage time of the original document 301 detected by the conveyance sensor 103 becomes the first passage time t1. Besides, the intermediate conveyance sensor 104 functions as the second sensor, and the passage time of the original document 301 detected by the intermediate conveyance sensor 104 becomes the second passage time t2. A skew amount s2 (skew angle θ) of the original document 301 immediately before reading is obtained from the difference between the passage times detected by the two sensors, and the absolute value of the skew amount s2 is compared with a threshold Smax2 to determine the occurrence of the skew. When it is determined that the skew occurs, similarly to the skew determination section 52a, an instruction is given so that the display section 55 displays to that effect, and in order to previously prevent a paper jam due to the skew from occurring, an instruction is given so that the conveyance control section 56 stops the conveyance of the original document 301.

When the skew determination sections 52a and 52b determine that the skew occurs, the skew correction section 54 performs a process to correct the inclination of image data read by the CCD sensor 20.

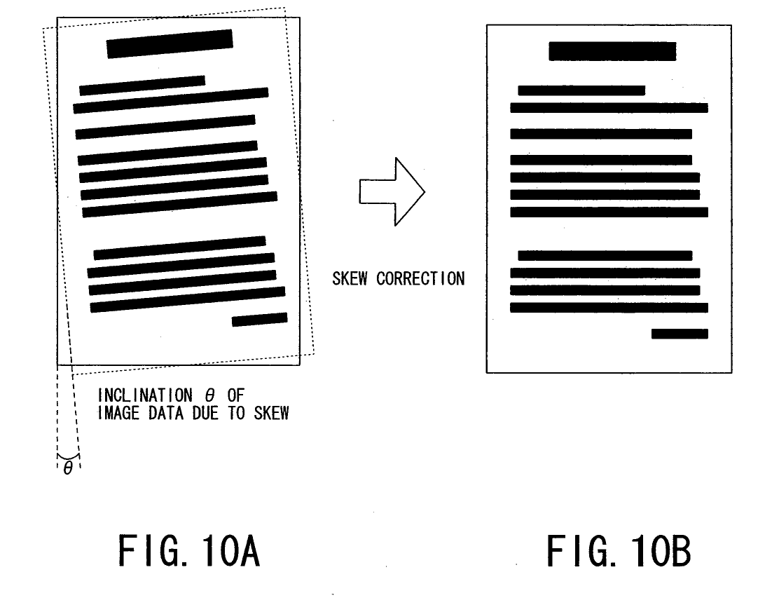

As exemplified in FIG. 10A, the image data read in the state where the skew occurs in the original document 301 is inclined according to the skew angle θ. Then, the skew correction section 54 corrects the inclination of the image data based on the skew angle θ obtained by the skew determination section (skew immediately before reading) 52b and can return it in an erected state. The skew determination section (skew at the time of paper feeding) 52a also obtains the skew angle θ, and the correction can be performed using this skew angle. However, when the correction is performed using the skew angle obtained just before the reading of the original document 301 by the CCD sensor 20, the correction with higher accuracy can be performed.

FIG. 9 is a view showing a structural example of the image reading apparatus 2 such as a scanner, and the respective function structures of the skew determination section 52, the conveyance speed determination section 53, the skew correction section 54, the display section 55, and the conveyance control section 56 are provided in, for example, the read control section 21 of the image reading apparatus 2. On the other hand, in the image forming apparatus 1 such as a copier or an MFP, the image forming section 30 to print read image data to a sheet is provided at a subsequent stage of the image reading apparatus 2, and the image forming section 30 also includes a control section for performing various controls and a processing section. Then, the respective function structures of the skew determination section 52, the conveyance speed determination section 53, the skew correction section 54, the display section 55, and the conveyance control section 56 shown in FIG. 9 may be provided in the control section and the like of the image forming section 30.

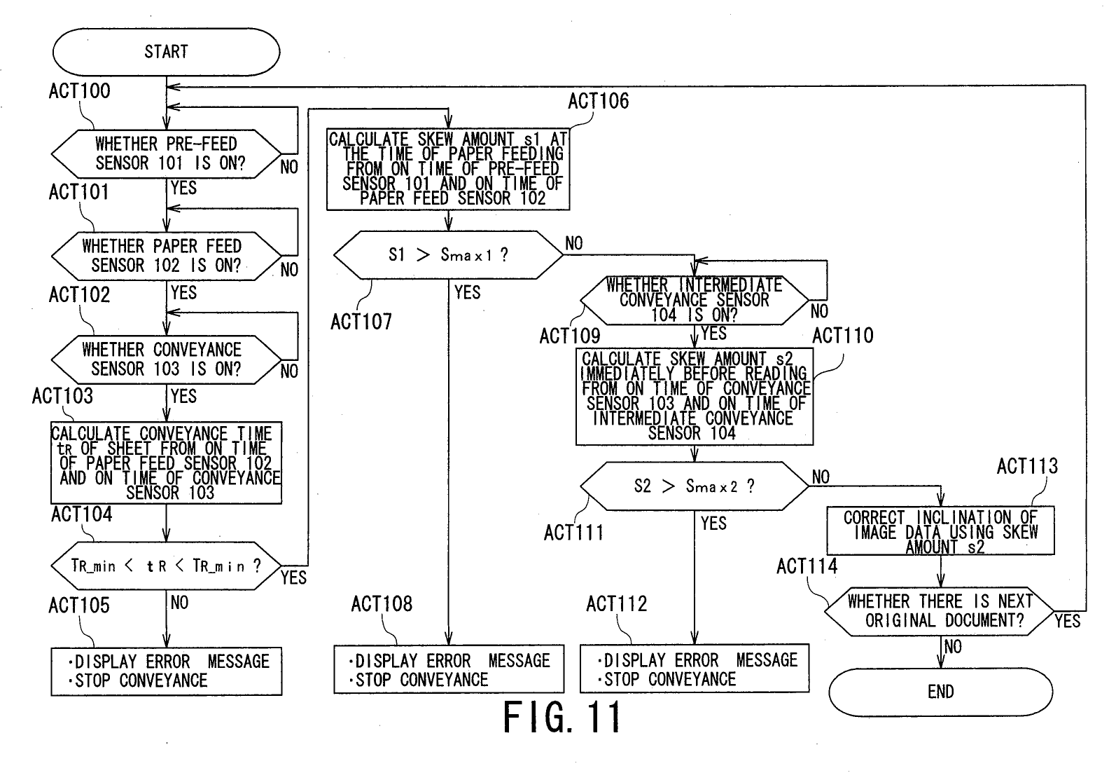

FIG. 11 is a flowchart mainly showing a process example which is performed by the skew determination section 52, the conveyance speed determination section 53, the skew correction section 54, the display section 55, and the conveyance control section 56 in the function blocks of FIG. 9.

At ACT 100, waiting is made for turning on of the pre-feed sensor 101, and when it is turned on, the ON time t1 is stored in an appropriate memory.

At ACT 101, waiting is made for turning on of the paper feed sensor 102, and when it is turned on, the ON time t2 is stored in an appropriate memory.

At ACT 102, waiting is made for turning on of the conveyance sensor 103, and when it is turned on, the ON time t3 is stored in an appropriate memory.

At ACT 103, a period t_{R} required for the original document 301 to be conveyed from the paper feed sensor 102 to the conveyance sensor 103 is calculated from the difference between the ON time t3 detected by the conveyance sensor 103 and the ON time t2 detected by the paper feed sensor 102 (t_{R}=t3−t2).

At ACT 104, it is determined whether the conveyance period t_{R} obtained at ACT 103 is within a specified range (range of from the minimum value T_{R}_{_{—}}ₘᵢₙ to the maximum value T_{R}_{_{—}}ₘₐₓ) (T_{R}_{_{—}}ₘᵢₙ<t_{R}<T_{R}ₘₐₓ).

At ACT 104, when it is determined that the conveyance period t_{R} is not within the specified range, since it is estimated that the conveyance speed V0 of the original document 301 is not normal because of a factor such as abrasion occurring in the roller, an error message of a conveyance function failure or the like is displayed. Besides, an instruction may be given so that the conveyance control section 56 to control the conveyance of the original document 301 stops the conveyance (ACT 105). Besides, in this case, even if the skew amount determination based on the conveyance speed V0 is performed, a correct skew amount can not be obtained. Thus, the skew amount determination and skew correction process (process after ACT 106) is not performed.

On the other hand, when it is determined that the conveyance speed of the original document 301 is normal (YES at ACT 104), the determination of the skew amount s1 (more specifically, the skew angle θ) at the time of paper feeding is performed.

At ACT 106, the skew amount s1 is calculated from the previously detected ON time t2 of the paper feed sensor 102 and the ON time t1 of the pre-feed sensor 101. Specifically, the difference (T=t2−t1) (passage period) between the ON time t2 of the paper feed sensor 102 and the ON time t1 of the pre-feed sensor 101 is obtained, and the obtained T is substituted into equation 1 to obtain the skew amount s1 at the time of paper feeding.

For the conveyance speed V0 in equation 1, a standard conveyance speed at the normal time may be used, or an actual conveyance speed at the present time (only when it is determined at ACT 104 that the conveyance speed is normal) based on the conveyance period t_{R} obtained at ACT 103 may be used.

At ACT 107, it is determined whether the absolute value of the skew amount s1 at the time of paper feeding calculated at ACT 106 does not exceed the specified limit value Smax1. When the skew amount s1 exceeds the specified limit value Smax1, a message indicating that a skew occurs is displayed, and in order to previously prevent a paper jam due to the skew from occurring, the conveyance of the original document 301 is stopped (ACT 108).

On the other hand, when the absolute value of the skew amount s1 at the time of paper feeding does not exceed the limit value Smax1 (NO at ACT 107), waiting is made for turning on of the intermediate conveyance sensor 104, and when it is turned on, the ON time t4 is stored in an appropriate memory (ACT 109).

At ACT 110, a period T required for the original document 301 to be conveyed from the conveyance sensor 103 to the intermediate conveyance sensor 104 is obtained from a difference between the ON time t4 detected by the intermediate conveyance sensor 104 and the ON time t3 detected by the conveyance sensor 103, and the obtained T is substituted into equation 1 to calculate the skew amount s2 immediately before reading.

It is determined whether the absolute value of the calculated skew amount s2 immediately before reading does not exceed the specified limit value Smax2 (ACT 111). When the skew amount s2 exceeds the specified limit value Smax2, a message indicating that a skew occurs is displayed, and in order to previously prevent a paper jam due to the skew from occurring, the conveyance of the original document 301 is stopped (ACT 112).

On the other hand, when the skew amount s2 does not exceed the specified limit value Smax2, although the conveyance of the original document 301 is continued, there is a possibility that the image data is inclined by the skew amount s2 not larger than the limit value Smax2. Then, the skew correction process to return the inclination of the image data to the erected state is performed by using the skew amount s2 immediately before reading, which is calculated at ACT 111 (ACT 112).

At ACT 114, the presence or absence of a next original document is determined, and when there is a next original document, a return is made to ACT 100, and the foregoing process is repeated.

As stated above, according to the image reading apparatus 2 and the image forming apparatus 1 of the embodiment, by using the paper detection sensors originally arranged for the purpose of detecting a paper jam, the skew amount of the original document 301 can be detected without newly increasing a sensor. Besides, in the sensor arrangement including at least two sensor arrangement sections different from each other in an angle formed between a straight line connecting two sensors of the arranged paper detection sensors and a straight line parallel to the conveyance direction, the conveyance time of each sensor section and the conveyance time of the section in the normal state are compared with each other, and comparison results of two or more sensor sections are combined to make a determination. As a result, the skew amount can be accurately calculated in view of the change of the sheet conveyance time due to the roller abrasion or the like. The skew correction of the read image data can be accurately performed based on the correctly calculated skew amount. Besides, the allowable value of the skew amount is previously determined, and the calculated skew amount is compared with the allowable value. When the skew amount exceeds the allowable value, the conveyance of the original document 301 can be stopped. As a result, the occurrence of paper wrinkle due to the excessive skew, and the occurrence of a paper jam can be prevented in advance, and the damage of the original document 301 can be avoided.

Besides, when the skew at the time of paper feeding is detected, the display section displays to that effect and can urge the user to take suitable measures for addressing the skew. For example, the display section urges the user to check the placement state of the original document on the original document tray, or urges the user to contact a maintenance serviceman.

The invention is not limited to the above embodiments, but the components can be modified and embodied at the practical stage within the scope not departing from the gist. Besides, the invention of various embodiments can be formed by suitable combination of plural components disclosed in the embodiments. For example, some components may be deleted from all components disclosed in the embodiment. Further, components in different embodiments may be suitably combined.

What is claimed is:

1. An image reading apparatus comprising:
an auto document feeder to automatically feed an original document along a conveyance path;
a first sensor that is provided on the conveyance path and detects a first passage time of the original document;
a second sensor that is provided at a position different from a position of the first sensor in a conveyance direction of the original document and also different therefrom in a direction perpendicular to the conveyance direction and detects a second passage time of the original document; and
a skew determination section that obtains a skew amount of the original document from a difference between the first passage time detected by the first sensor and the second passage time detected by the second sensor and determines occurrence of askew of the original document based on the skew amount.

2. The apparatus of claim 1, further comprising a conveyance control section to stop conveyance of the original document when the skew amount determined by the skew determination section is larger than a specified reference value.

3. The apparatus of claim 1, further comprising a display section to display a message indicating the occurrence of the skew when the skew determination section determines that the skew occurs.

4. The apparatus of claim 1, wherein
when a passage period of the original document obtained from the difference between the first passage time t1 and the second passage time t2 is T, a passage period of the original document between the first sensor and the second sensor when there is no skew is T0, a distance between the first sensor and the second sensor in the direction perpendicular to the conveyance direction is L, and a conveyance speed of the original document is V, the skew determination section obtains the skew amount θ by
tan θ=(T0−T)·(V/L),
and when the skew amount θ is larger than a specified reference range, the skew determination section determines that the skew of the original document occurs.

5. The apparatus of claim 1, further comprising a skew correction section to correct an inclination of an image read from the original document by using the skew amount when the skew determination section determines that the skew of the original document occurs.

6. The apparatus of claim 1, further comprising:
a third sensor that is disposed on the conveyance path of the original document, is arranged at a position shifted from a straight line connecting the position of the first sensor and the position of the second sensor, and detects a third passage time of the original document; and
a conveyance speed determination section to determine a conveyance speed of the original document by the third passage time detected by the third sensor and at least one of the first passage time and the second passage time, wherein
the skew determination section determines the occurrence of the skew when the conveyance speed determined by the conveyance speed determination section is within a specified range.

7. The apparatus of claim 6, further comprising a conveyance control section to stop conveyance of the original document when the conveyance speed determined by the conveyance speed determination section is outside the specified range.

8. An image forming apparatus comprising:
an auto document feeder to automatically feed an original document along a conveyance path;
a first sensor that is provided on the conveyance path and detects a first passage time of the original document;
a second sensor that is provided at a position different from a position of the first sensor in a conveyance direction of the original document and also different therefrom in a direction perpendicular to the conveyance direction and detects a second passage time of the original document;
a skew determination section that obtains a skew amount of the original document from a difference between the first passage time detected by the first sensor and the second passage time detected by the second sensor and determines occurrence of a skew of the original document based on the skew amount;
a line sensor to read the original document fed by the auto document feeder; and
an image forming section to print image data of the original document read by the line sensor onto a sheet.

9. The apparatus of claim 8, further comprising a conveyance control section to stop conveyance of the original document when the skew amount determined by the skew determination section is larger than a specified reference value.

10. The apparatus of claim 8, further comprising a display section to display a message indicating the occurrence of the skew when the skew determination section determines that the skew occurs.

11. The apparatus of claim 8, wherein
when a passage period of the original document obtained from the difference between the first passage time t1 and the second passage time t2 is T, a passage period of the original document between the first sensor and the second sensor when there is no skew is T0, a distance between the first sensor and the second sensor in the direction perpendicular to the conveyance direction is L, and a conveyance speed of the original document is V, the skew determination section obtains the skew amount θ by
tan θ=(T0−T)·(V/L),
and when the skew amount θ is larger than a specified reference range, the skew determination section determines that the skew of the original document occurs.

12. The apparatus of claim 8, further comprising a skew correction section to correct an inclination of an image read from the original document by using the skew amount when the skew determination section determines that the skew of the original document occurs.

13. The apparatus of claim 8, further comprising:
a third sensor that is disposed on the conveyance path of the original document, is arranged at a position shifted from a straight line connecting the position of the first sensor and the position of the second sensor, and detects a third passage time of the original document; and
a conveyance speed determination section to determine a conveyance speed of the original document by the third passage time detected by the third sensor and at least one of the first passage time and the second passage time, wherein
the skew determination section determines the occurrence of the skew when the conveyance speed determined by the conveyance speed determination section is within a specified range.

14. A method for image reading, comprising:
automatically feeding an original document along conveyance path by an auto document feeder;
detecting a first passage time of the original document by a first sensor provided on the conveyance path;
detecting a second passage time of the original document by a second sensor provided at a position different from a position of the first sensor in a conveyance direction of the original document and also different therefrom in a direction perpendicular to the conveyance direction;
obtaining a skew amount of the original document from a difference between the first passage time detected by the first sensor and the second passage time detected by the second sensor; and
determining occurrence of a skew of the original document based on the skew amount.

15. The method of claim 14, further comprising:
stopping conveyance of the original document when the determined skew amount is larger than a specified reference value.

16. The method of claim 14, further comprising:
displaying a message indicating the occurrence of the skew when it is determined that the skew occurs.

17. The method of claim 14, wherein
in the determining the occurrence of the skew, when a passage period of the original document obtained from the difference between the first passage time t1 and the second passage time t2 is T, a passage period of the original document between the first sensor and the second sensor when there is no skew is T0, a distance between the first sensor and the second sensor in the direction perpendicular to the conveyance direction is L, and a conveyance speed of the original document is V, the skew amount θ is obtained by
tan θ=(T0−T)·(V/L),
and when the skew amount θ is larger than a specified reference range, it is determined that the skew of the original document occurs.

18. The method of claim 14, further comprising:
correcting an inclination of an image read from the original document by using the skew amount when it is determined that the skew of the original document occurs.

19. The method of claim 14, further comprising:
detecting a third passage time of the original document by a third sensor that is disposed on the conveyance path of the original document, and is arranged at a position shifted from a straight line connecting the position of the first sensor and the position of the second sensor; and
determining a conveyance speed of the original document by the third passage time detected by the third sensor and at least one of the first passage time and the second passage time, wherein
in the determining the occurrence of the skew, the occurrence of the skew is determined when the determined conveyance speed is within a specified range.

20. The method of claim 19, further comprising:
stopping conveyance of the original document when the determined conveyance speed is outside the specified range.
